(19) United States
(12) Patent Application Publication
(10) Pub. No.: US 2025/0323914 A1
(43) Pub. Date: Oct. 16, 2025

(54) PHISHING RESISTANT ENROLLMENT VIA AN OPERATING SYSTEM

(71) Applicant: OKTA, INC., SAN FRANCISCO, CA (US)

(72) Inventors: Dipti Vivek SHIRALKAR, San Jose, CA (US); Tanvir Arefin AHMED, Kirkland, WA (US); Desmond Dik Ming WONG, Thornhill (CA); Ildar ABDULLIN, Brentwood, CA (US); Umang SHAH, Fremont, CA (US)

(21) Appl. No.: 18/633,103

(22) Filed: Apr. 11, 2024

(51) Int. Cl. H04L 9/40

(52) U.S. Cl. CPC H04L 63/0884; H04L 63/1483

(57) ABSTRACT

An operating system of a first device associated with an identity provider (IdP) may receive an enrollment configuration request from a device management provider for the first device to enroll in an authentication service provided by the IdP. In accordance with the enrollment configuration request, the operating system of the first device may provide the first device that is associated with a first user with a prompt to initiate the enrollment of the first device into the authentication service. The operating system may then transmit an enrollment request message to an authentication server associated with the authentication service. The enrollment request message may also include data associated with the first device that is requesting enrollment in the authentication service where an attestation that the first device is associated with an organization is based on the enrollment request message.

### FIELD OF TECHNOLOGY

The present disclosure relates generally to identity management, and more specifically to phishing resistant enrollment via an operating system.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

In some examples, one or more fraudulent users may attempt to access the identity management system. Fraudulent users may attempt to steal or access user data via phishing attacks. Phishing (e.g., phishing attacks) may include users receiving messages where someone pretends to be a person, brand, or user, that a user may trust (e.g., a fraudulent user). In some examples, the fraudulent user may attempt to solicit personal or confidential information from the user without their direct knowledge. Therefore, phishing may expose the user data of users resulting in a decrease in the security, reliability, and effectiveness of an application, device, or service.

### SUMMARY

A method for authentication service enrollment by an apparatus is described. The method may include receiving, from a device management provider, an enrollment configuration request for an authentication service, providing, to a first device associated with a first user, a prompt to initiate enrollment in the authentication service, the enrollment being in accordance with the enrollment configuration request, where the first device is managed by a second user of an organization that is different from the first user and is associated with the device management provider, and transmitting, to an authentication server associated with the authentication service, an enrollment request message including data associated with the first device, the enrollment request message requesting the enrollment of the first device in the authentication service, where the enrollment request message is transmitted based on the prompt to initiate the enrollment, and where an attestation that the first device is associated with the organization is based on the enrollment request message.

An apparatus for authentication service enrollment is described. The apparatus may include one or more memories storing processor executable code, and one or more processors coupled with the one or more memories. The one or more processors may individually or collectively be operable to execute the code to cause the apparatus to receive, from a device management provider, an enrollment configuration request for an authentication service, provide, to a first device associated with a first user, a prompt to initiate enrollment in the authentication service, the enrollment being in accordance with the enrollment configuration request, where the first device is managed by a second user of an organization that is different from the first user and is associated with the device management provider, and transmit, to an authentication server associated with the authentication service, an enrollment request message including data associated with the first device, the enrollment request message requesting the enrollment of the first device in the authentication service, where the enrollment request message is transmitted based on the prompt to initiate the enrollment, and where an attestation that the first device is associated with the organization is based on the enrollment request message.

Another apparatus for authentication service enrollment is described. The apparatus may include means for receiving, from a device management provider, an enrollment configuration request for an authentication service, means for providing, to a first device associated with a first user, a prompt to initiate enrollment in the authentication service, the enrollment being in accordance with the enrollment configuration request, where the first device is managed by a second user of an organization that is different from the first user and is associated with the device management provider, and means for transmitting, to an authentication server associated with the authentication service, an enrollment request message including data associated with the first device, the enrollment request message requesting the enrollment of the first device in the authentication service, where the enrollment request message is transmitted based on the prompt to initiate the enrollment, and where an attestation that the first device is associated with the organization is based on the enrollment request message.

A non-transitory computer-readable medium storing code for authentication service enrollment is described. The code may include instructions executable by one or more processors to receive, from a device management provider, an enrollment configuration request for an authentication service, provide, to a first device associated with a first user, a prompt to initiate enrollment in the authentication service, the enrollment being in accordance with the enrollment configuration request, where the first device is managed by a second user of an organization that is different from the first user and is associated with the device management provider, and transmit, to an authentication server associated with the authentication service, an enrollment request message including data associated with the first device, the enrollment request message requesting the enrollment of the first device in the authentication service, where the enrollment request message is transmitted based on the prompt to initiate the enrollment, and where an attestation that the first device is associated with the organization is based on the enrollment request message.

Some examples of the method, apparatus, and non-transitory computer-readable medium described herein may further include operations, features, means, or instructions for receiving, from the authentication server, a response message indicating that the first device may be enrolled in the authentication service, the first device being enrolled in the authentication service based on the data of the enrollment request message.

Some examples of the method, apparatus, and non-transitory computer-readable medium described herein may further include operations, features, means, or instructions for generating a signed device attestation to indicate that the first device may be associated with the organization of the device management provider using a signed authentication certificate issued by the device management provider associated with the organization, where the enrollment request message includes the signed device attestation.

Some examples of the method, apparatus, and non-transitory computer-readable medium described herein may further include operations, features, means, or instructions for receiving, from the authentication server associated with the authentication service, an enrollment denial message that indicates a denial of the enrollment of the first device in the authentication service based on the attestation of the first device and displaying, at a first user interface of the first device, the enrollment denial message based on receiving the enrollment denial message.

In some examples of the method, apparatus, and non-transitory computer-readable medium described herein, the prompt to initiate the enrollment of the first device associated with the first user in the authentication service may include operations, features, means, or instructions for receiving, from the first user, one or more user inputs to associate the first user with the first device, the first device being associated with an identity provider that provides the authentication service, where the attestation that the first device may be associated with the organization may be based on the one or more user inputs.

In some examples of the method, apparatus, and non-transitory computer-readable medium described herein, the prompt to initiate the enrollment in the authentication service may be displayed at a first user interface of the first device.

In some examples of the method, apparatus, and non-transitory computer-readable medium described herein, the second user of the organization associated with the device management provider may be an administrative user for the device management provider.

### BRIEF DESCRIPTION OF THE DRAWINGS

FIGS. 1 and 2 illustrate examples of a computing system that phishing resistant enrollment via an operating system in accordance with aspects of the present disclosure.

FIG. 3 shows an example of a process flow that supports phishing resistant enrollment via an operating system in accordance with aspects of the present disclosure.

FIG. 4 shows a block diagram of an apparatus that supports phishing resistant enrollment via an operating system in accordance with aspects of the present disclosure.

FIG. 5 shows a block diagram of an operating system module that supports phishing resistant enrollment via an operating system in accordance with aspects of the present disclosure.

FIG. 6 shows a diagram of a system including a device that supports phishing resistant enrollment via an operating system in accordance with aspects of the present disclosure.

FIG. 7 shows a flowchart illustrating methods that support phishing resistant enrollment via an operating system in accordance with aspects of the present disclosure.

### DETAILED DESCRIPTION

In some examples, services or applications may implement one or more software authentication procedures to authenticate users. Software authentication procedures may ensure that users can only access data that the respective user has permission to access. In some examples, users of an organization may use various services or applications to access a respective service or application, and the user may be expected to verify their identity via an authentication procedure (e.g., entering a password, entering a passcode, biometrics, or any other type of authentication technique). However, users of organizations may use a relatively large quantity of services and applications, and performing an authentication procedure for each service or application may be relatively time consuming.

In some examples, to reduce the delay of accessing the applications or services, the user may enroll and register in a single sign-on (SSO) service that can authenticate the user, for various services, via a one or more credentials. For example, the SSO service may be connected to an authentication server associated with the organization that the user is a member of, where the authentication server may include information related to the levels of access the user may have. In some other examples, users may enroll in a multi-factor authenticator (MFA) service that enables a password-less authentication and provides phishing resistant authentication. However, the enrollment into SSO services, MFA services, or a combination thereof, may be susceptible to phishing attacks. For example, to enroll in such services, users may receive an email with a uniform resource locator (URL) that is a link to an enrollment page or website. However, the email received by the user may be a phishing attempt from a fraudulent user that is designed to attempt to steal information.

To prevent users from being subjected to phishing attacks, the techniques of the present disclosure may describe an authentication service (e.g., SSO service, MFA service) enrollment procedure that is phishing resistant. For example, the techniques of the present disclosure may describe an operating system of a computing device initiating an authentication service enrollment, rather than a user initiating the enrollment. To support the techniques of the present disclosure, the operating system of a computing device may receive an enrollment configuration request from a device management provider (e.g., a mobile device management (MDM) provider) that indicates a configuration for enrolling a device in an authentication service in accordance with the techniques of the present disclosure. By using the enrollment configuration request, the operating system may transmit a prompt to a first user of a first device (e.g., a computing device) running the operating system to initiate the enrollment in an authentication service. Further, the first device may be a managed device such that an administrative user (e.g., a second user) of an organization or company that is associated with the device management provider manages and controls the first device.

Based on the initiation of the enrollment of the first device in the authentication service, the operating system of the first device may transmit an enrollment request message to an authentication server to complete the enrollment. The enrollment request message may include data that is associated with the first device that the authentication server can use to attest the device as a managed device of the organization (e.g., associated with the device management provider). Once the first device is attested as being a managed device, the first device may be enrolled in the authentication service. Therefore, the operating system of the first device may initiate the enrollment into the authentication service and the first device may be attested as being managed by an organization prior to enrollment. Thus, the techniques of the present disclosure may ensure that the enrollment of the first device into an authentication service is phishing resistant as the organization managing the first device controls the authentication service enrollment.

In some cases, attesting the first device as being a managed device and being associated with the organization prior to enrollment in the authentication service may provide a relatively higher level of security. For example, performing the device attestation prior to completing the authentication service enrollment may ensure that the first device has permissions to access the data of the applications or services prior to granting the first device access to the applications or services via the authentication service. Moreover, if the authentication server determines that the first device is associated with an organization different than the organization of the device management provider, the operating system of the first device may receive an enrollment denial message. Therefore, the techniques of the present disclosure may ensure that devices associated with different organizations are prevented from enrolling within the authentication service, thus providing a robust and secure authentication service enrollment.

Further, the techniques of the present disclosure may ensure that the authentication service enrollment is phishing resistant by having the administrators of the organization associated with the device management provider manage the enrollment. For example, the enrollment configuration request from the device management provider may include data associated with initiating the authentication service enrollment. Moreover, the data of the enrollment configuration request may instruct the operating system of the device that received the enrollment configuration request (e.g., the first device) to use such data to initiate the enrollment of the authentication service. Therefore, the device management provider may control and manage the enrollment of the authentication service, thus preventing phishing attacks from outside users. For example, if the first user of the first device initiates the authentication service enrollment, the initiation selection may be spoofed by fraudulent users in order to steal (e.g., maliciously obtain) information from the first user. Thus, by preventing the first user of the first device from initiating the authentication service enrollment, the techniques of the present disclosure may provide for phishing resistant authentication service enrollment, resulting in an increase in security and reliability in the authentication service.

Aspects of the disclosure are initially described in the context of a computing system. Additional aspects of the disclosure are described with reference to a computing system and a process flow. Aspects of the disclosure are further illustrated by and described with reference to apparatus diagrams, system diagrams, and flowcharts that relate to phishing resistant enrollment via an operating system.

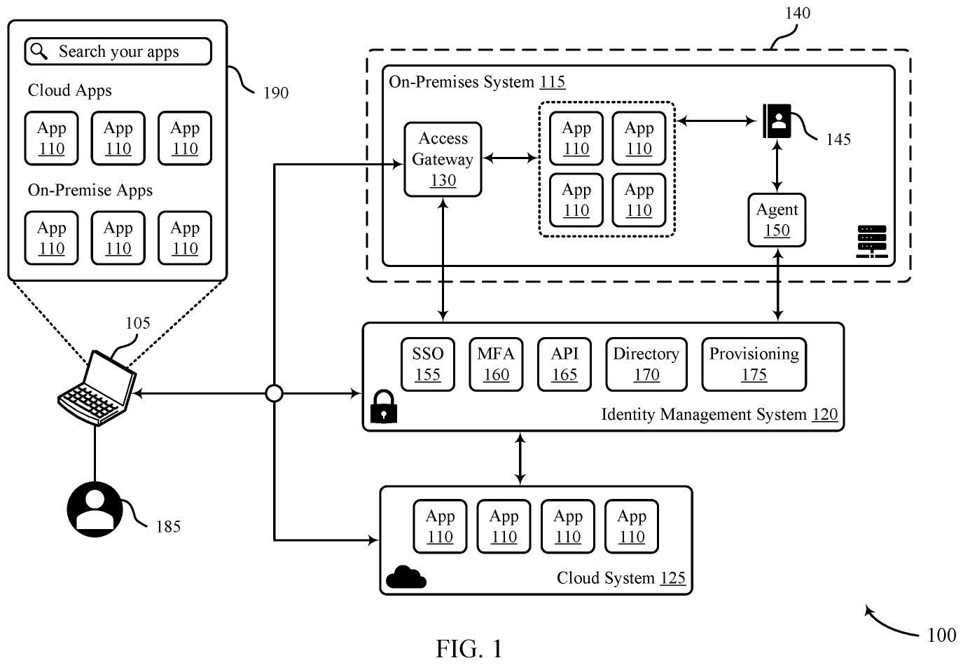

FIG. 1 illustrates an example of a computing system 100 that supports phishing resistant enrollment via an operating system in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an application programming interface (API) service 165, a directory management service 170, or a provisioning service 175 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, and/or the provisioning service 175 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization's APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

In some examples, the identity management system 120 may include an authentication server that supports the enrollment of a device (e.g., the computing device 105) in an authentication service, such as the SSO service 155 or the MFA service 160. In some cases, the operating system of the computing device 105 may receive an enrollment configuration request from a device management provider, which may be associated with the on-premises system 115 or the cloud system 125. The enrollment configuration request may indicate a configuration for enrolling the computing device 105 in the authentication service in a manner that is resistant to phishing attacks in accordance with the techniques of the present disclosure. Further, in some examples, the operating system of the computing device 105 may initiate the enrollment in the authentication service based on the enrollment configuration request. For example, the operating system may transmit a prompt to the user 185 of the computing device 105 to initiate the enrollment in the authentication service. In some cases, the computing device 105 may be a managed device such that an administrative user 185 of an organization or company associated with the device management provider manages and controls the computing device 105. The operating system of the computing device 105 may further transmit an enrollment request message to the authentication server of the identity management system 120 to complete the enrollment. Once the authentication server of the identity management system 120 attests the computing device 105 as being managed by the organization associated with the device management provider, the computing device 105 can be enrolled in the authentication service. Therefore, by having the operating system of the computing device 105 initiate the enrollment into the authentication service and by attesting the computing device 105 prior to the enrollment, the techniques of the present disclosure may ensure that the enrollment of the computing device 105 into an authentication service is phishing resistant as the organization managing the computing device 105 controls the authentication service enrollment.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

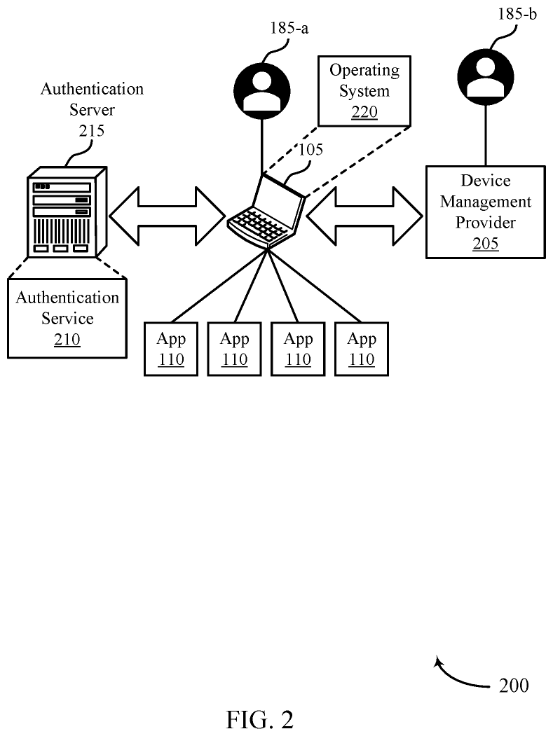

FIG. 2 shows an example of a computing system 200 that supports phishing resistant enrollment via an operating system in accordance with aspects of the present disclosure. In some examples, the computing system 200 may be implemented by or may implement the computing system 100. For example, the computing system 200 may include a user 185-a (e.g., a first user 185) of a computing device 105 that is managed by a user 185-b (e.g., an administrator user 185) of an organization associated with a device management provider 205, which may be examples of devices and services described with reference to FIG. 1. Further, the user 185-a may use an authentication service 210 associated with an authentication server 215 to authenticate the access of the user 185-a to access the one or more applications 110 of the computing device 105.

In some examples, the user 185-a may be one of a set of users 185 of an organization that includes one or more administrative users 185 (e.g., the user 185-b). The user 185-a may operate a computing device 105 that is managed by the organization of the user 185-a. Therefore, the computing device 105 may be referred to as a managed device. Further, the user 185-a may use one or more applications 110 on the computing device 105. In some cases, to access the one or more applications 110, the user 185-a may have to log-in or provide some authentication to gain access to a respective application 110 or an account of a respective application 110. For example, to access an application 110, the user 185-a may provide a username and password associated with the user 185-a. The computing device 105 running the application 110 may then communicate with an authentication server to authenticate the user 185-a and the access assigned to the user 185-a within the application 110. In some cases, the authentication may also include a dual factor authentication or MFA that requests the user 185-a enter a code or pin. In some examples, the user 185-a may obtain the code or pin from an authentication manager application 110 or the user may receive a message containing the code of pin (e.g., an email, a text message, a phone call, a push notification, or any combination thereof). Additionally, or alternatively, the code or pin may be time-based and can expire after a set duration (e.g., 15 minutes).

However, as the user 185-a may use a relatively large quantity of applications 110, authenticating the user 185-a each time the user 185-a attempts to access the one or more applications 110 of the computing device 105 can be relatively time-consuming and can consume a relatively large quantity of computational resources. Therefore, to reduce the time and computational resources used to authenticate the user 185-a with access to the one or more applications 110, the user 185-b may enroll the user 185-a into the authentication service 210.

The authentication service 210 may be an example of the SSO service 155 or the MFA service 160 described with reference to FIG. 1. In some examples, the authentication service 210 may provide the user with password-less authentication to the one or more applications 110. For example, after registration with the authentication service 210, the computing device 105 may be capable of access the one or more applications 110 in a password-less manner based on the computing device 105 being registered with the authentication service 210. In some cases, the administrative user 185 (e.g., the user 185-b) of the organization the user 185-a belongs to may manage and control the password-less authentication based on an authentication policy configured by the user 185-b. Additionally, or alternatively, the authentication service 210 may be integrated with biometrics at the computing device 105 to provide access to the one or more applications 110 to avoid extra prompts. For example, the authentication service 210 may use the biometric data of the user 185-a (e.g., a facial scan, a fingerprint scan, or a combination thereof) to enable the user 185-a access to a respective application 110. Further, the user 185-b may configure the authentication service 210 to be such that the computing device 105 may be registered with the authentication service 210 if the computing device 105 is a managed device that is controlled by the organization of the user 185-a (e.g., controlled by the user 185-b that is an administrative user 185 of the organization).

To register within the authentication service 210, the user 185-a may receive a link to trigger the registration of the computing device 105 into the authentication service 210. In some cases, the user 185-a may receive the link via an email or text message. However, as described herein, in some cases, a fraudulent user may transmit the message including the link to register the computing device 105 in the authentication service 210. For example, the user 185-a may receive an email (e.g., a phishing message) from a fraudulent user 185 that is impersonating the user 185-b to gain the trust of the user 185-a. Further, the email may be relatively difficult for the user 185-a to discern as a phishing email, as the email may seem as if the message is from the user 185-b which is a legitimate and trusted source.

In some examples, the phishing message may include a link that directs the user 185-a to a website that looks relatively identical to the actual registration website, but may include one or more aspects that can be used to steal information from the user 185-a. For example, the website may be edited to include an inline frame (iFrame) that is transparent to the user 185-a and that overlaps with text input boxes. An iFrame may be used in a hypertext markup language (HTML) document to embed interactive media (e.g., login pages, pages to enter shipping addresses or payment information). Therefore, the website may have an iFrame that may be transparent to a user 185-a, and the iFrame may be overlapping with a text input box that prompts the user 185-a to provide login credentials. Thus, the user 185-a may be providing the login credentials to the fraudulent user 185 instead of the authentication service 210.

To safeguard user 185 accounts, protect sensitive information, and reduce the risk of successful phishing attacks, the techniques of the present disclosure may describe enabling the enrollment and registration into the authentication service 210 to be phishing resistant to enhance security and promote a relatively safer online environment for user 185, organizations, or both. For example, the techniques of the present disclosure may describe enabling an SSO extension framework provided by an operating system 220 of the computing device 105 to make the authentication service 210 enrollment phishing resistant. In some cases, the enrollment of the computing device 105 into the authentication service 210 may be triggered by the SSO extension during an inline enrollment flow. In some other cases, the enrollment of the computing device 105 into the authentication service 210 may be triggered during the registration of the SSO service at the computing device 105. For example, a system level service maintained by an IdP that provides the authentication service 210 may trigger the enrollment of the computing device 105 into the authentication service 210. Further, the techniques of the present disclosure may also ensure that the enrollment into the authentication service 210 is performed by a managed device (e.g., the computing device 105 that is managed by the organization of the user 185-a) by attesting device signals.

In some examples, the SSO registration flow may be enabled by the organization that manages the computing device 105 deploying a device management provider 205 profile (e.g., a mobile device management (MDM) profile). The device management provider 205 may be configured to send profiles and commands to devices (e.g., computing device 105) owned by the organization associated with the device management provider 205. In some cases, the device management provider 205 may be capable of sending wireless or remotely updating a computing device 105, changing the settings of a computing device, accessing the usage of the computing device, wiping or deleting data stored on the computing device 105, or a combination thereof. Therefore, the device management provider 205 may be capable of managing and controlling computing devices 105 that are associated with the same organization of the device management provider 205.

On the deployment of a device management provider 205 profile on the computing device 105 for the SSO enrollment, the operating system 220 of the computing device 105 may notify the user 185-a to start the registration process into the SSO service, the authentication service 210, or both. That is, the operating system 220 may prompt the user 185-a of the computing device 105 to begin the enrollment into the authentication service 210 When the user 185-a starts the registration process, the operating system 220 may transmit a call back to the SSO extension to initiate or orchestrate the registration flow. Further, in some cases, users 185 may be enrolled in the authentication service 210 along with the SSO service registration flow. Additionally, or alternatively, the operating system 220 may redirect the user 185-a to a trusted URL to enroll the computing device 105 in the authentication service 210. For example, the user 185-b may indicate the URL for enrollment in the authentication service 210 within the enrollment configuration that is pushed from the device management provider 205 to the operating system 220 of the computing device 105-a. Therefore, the enrollment into the authentication service 210 may be phishing resistant as the URL for enrollment is determined by the user 185-b and the device management provider 205.

Further, since the operating system 220 may automatically redirect the user 185-a to a trusted URL, phishing attacks may be unable to be completed as enrollment is initiated internally by the operating system 220 rather than externally by the user 185-a selecting a link which can be a part of a phishing attack. Therefore, since the flow is triggered by the device management provider 205 profile and driven by the operating system 220 of the computing device 105, the registration may be phishing resistant due to the lack of external factors involved. Further, if an extendible SSO profile deployed by the device management provider 205 includes a URL to be access by the user 185-a, the operating system 220 of the computing device 105 may allow the SSO extension to handle the authentication for the URL. Therefore, if the user 185-a is not enrolled in the authentication service 210, the SSO extension may trigger the inline enrollment flow for the user 185-a to enroll the computing device 105 in the authentication service 210.

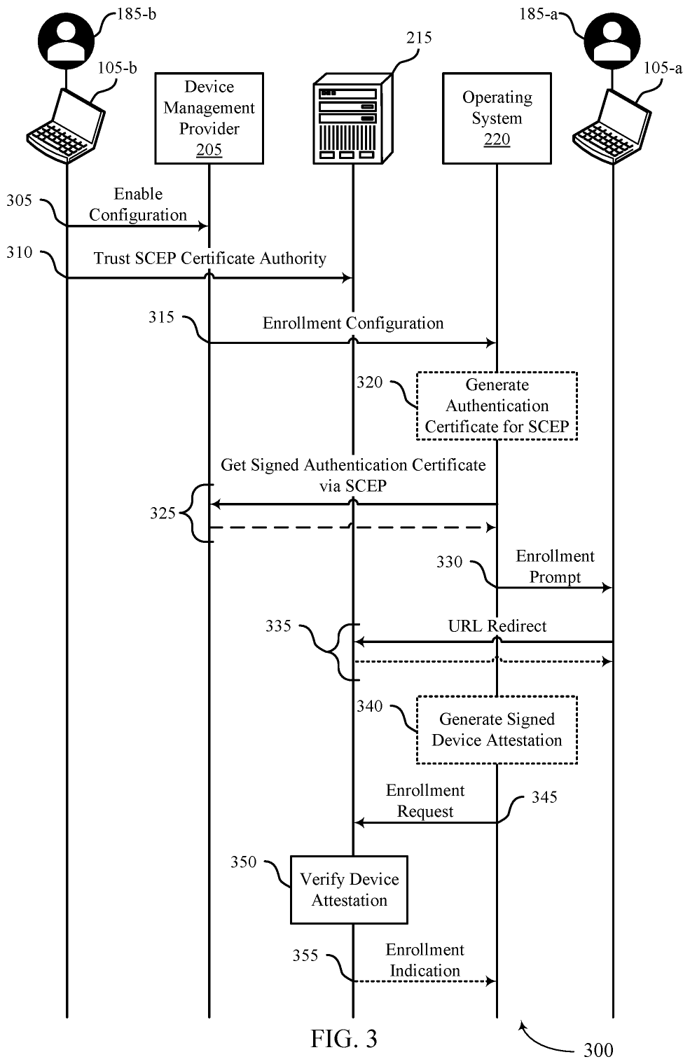

Thus, the techniques of the present disclosure may enable phishing resistant enrollments as the operating system 220 of the computing device 105 may validate the URL before giving control of the enrollment to the SSO extension. For example, as described with reference to FIG. 3, the user 185-b and the device management provider 205 may specify the URL for the operating system 220 of the computing device 105 to redirect the user 185-a to for enrolling in the authentication service 210. Therefore, fraudulent users may be unable to insert any fraudulent URLs or link for the user to select as the operating system 220 may automatically redirect the user 185-a to a trusted URL for enrollment. Further descriptions of the phishing resistant enrollment procedure may be described elsewhere herein, such as with reference to FIG. 3.

FIG. 3 shows an example of a process flow 300 that supports phishing resistant enrollment via an operating system in accordance with aspects of the present disclosure. In some examples, the process flow 300 may be implemented by or may implement the computing system 100, the computing system 200, or both. For example, the process flow 300 may include a computing device 105-b associated with a user 185-b (e.g., an administrative user 185), a device management provider 205, an authentication server 215, an operating system 220, and a computing device 105-a associated with a user 185-a (e.g., an end user 185) which may be examples of devices or services described elsewhere herein with reference to FIGS. 1 and 2. Further, in some examples, the computing device 105-a may operate on the operating system 220 and the operating system 220 may communicate with the authentication service 210 and the authentication server 215 on the behalf of the user 185-a of the computing device 105-a. Moreover, the user 185-a and the user 185-b may both be associated with an organization where the user 185-a is a first user of an organization, and the user 185-b is a second user of the organization that is associated with the device management provider 205 and the user 185-b is an administrative user 185 for the device management provider 205 of the organization.

In the following description of the process flow 300, the operations between the computing device 105-a, device management provider 205, the authentication server 215, the operating system 220, and the computing device 105-b may be performed in different orders or at different times. Some operations may also be left out of the process flow 300, or other operations may be added. Although the computing device 105-a, device management provider 205, the authentication server 215, the operating system 220, and the computing device 105-b are shown performing the operations of the process flow 300, some aspects of some operations may also be performed by one or more other devices, services, or models described elsewhere herein including with reference to FIG. 1.

At 305, the user 185-b of the computing device 105-b may enable an enrollment configuration for the device management provider 205 to distribute. In some examples, the enrollment configuration may include an enrollment URL (e.g., a platform SSO enrollment URL) for enrollment of a computing device 105 into the authentication service 210 described with reference to FIG. 2. Therefore, the URL for enrollment may be directly indicated by the user 185-b and directly provided to the device management provider 205 to prevent phishing from occurring when the enrollment URL reaches the user 185-a. In some cases, the enrollment configuration may also include a simple certificate enrollment protocol (SCEP) configuration. SCEP may be an example of a management protocol used for requesting and issuing authentication certificates in a simplistic manner. Further, at 310, the user 185-b of the computing device 105-b may authorize the authentication server 215 that is associated with the authentication service 210 as a trusted SCEP certificate authority to enable the authentication server 215 to trust devices (e.g., computing devices 105) based on the SCEP configuration.

At 315, the operating system 220 of the computing device 105-a may receive, from the device management provider 205, an enrollment configuration request for the authentication service 210. That is, the device management provider 205 may push the enrollment configuration of the authentication service 210 to the computing device 105-a to have the computing device 105-a enroll in the authentication service 210. Further, the operating system 220 may receive the enrollment configuration such that the operating system 220 is capable of initiating the enrollment flow of the authentication service 210.

At 320, as part of the SCEP procedure to authenticate the computing device 105-a, the operating system 220 may generate a private key for the computing device 105-a (e.g., the operating system 220 may generate an authentication certificate or client certificate for the SCEP procedure). As such, at 325, as part of the SCEP procedure, the computing device 105-a may communicate with the device management provider 205. For example, the computing device 105-a may transmit an indication of the private key of the computing device 105-a to the device management provider 205 to authenticate the computing device 105-a. In response, the device management provider 205 may generate a signed authentication certificate that is issued by the device management provider 205 where the device management provider 205 is associated with an organization of the user 185-a and the user 185-b, wherein the enrollment request message includes the signed device attestation.

At 330, the operating system 220 may provide, to the computing device 105-a associated with the user 185-a, a prompt to initiate enrollment in the authentication service 210. That is, the operating system 220 may initiate the enrollment of the computing device 105-a in the authentication service 210. In some cases, the enrollment int the authentication service 210 may occur at the same time or separately from the enrollment in an SSO authenticator or a platform authenticator to make both enrollments phishing resistant. Further, the enrollment may be in accordance with the enrollment configuration request received from the device management provider 205. Moreover, the computing device 105-a may be managed by the user 185-b of an organization (e.g., the organization of the user 185-a) where the user 185-b is different from the user 185-a and is associated with (e.g., an administrative user 185 of) the device management provider 205.

In some examples, the prompt that initiates the enrollment may include the operating system 220 receiving, from the user 185-a of the computing device 105-a, one or more user 185 inputs to associated the user 185-a with the computing device 105-a based on the computing device 105-a being associated with an IdP that provides the authentication service 210. That is, the operating system 220 may receive user 185 inputs from the user 185-a to associate that the user 185-a is an operator of the computing device 105-a or that the user 185-a is the user 185 of the computing device 105-a. In some cases, the prompt to initiate the enrollment in the authentication service 210 may also be displayed at a first UI of the computing device 105-a.

At 335, the user 185-a may be automatically redirected to the trusted URL indicated by the user 185-b that is associated with the device management provider 205 to authenticate the user 185-a and enroll the computing device 105-a into the authentication service 210. Therefore, phishing may be unable to occur as the URLs for enrollment may be specified by the user 185-b (e.g., the administrative user 185 of the organization), the device management provider 205, and an SSO extension. For example, since the enrollment URL is preconfigured by the user 185-b, the operating system 220 may automatically route the user 185-a to the enrollment URL to enroll in the authentication service 210, thus preventing the ability of the user 185-a from selecting or clicking on a phishing URL when enrolling in the authentication service 210.

At 340, in response to the user 185-a being redirected to the trusted URL for enrollment in the authentication service 210, the operating system 220 may generate a signed device attestation to indicate that the computing device 105-a is associated with the device management provider 205 using the signed authentication certificate issued by the device management provider 205 associated with the organization, where the enrollment request message includes the signed device attestation. Further, in some examples, the attestation that the device is associated with the organization may be based on the one or more user 185 inputs from the user 185-a via the enrollment initiation prompt. At 345, the operating system 220 may transmit, to the authentication server 215 associated with the authentication service 210, an enrollment request message that includes data associated with the computing device 105-a.

Further, the enrollment request message may request the enrollment of the computing device 105-a in the authentication service 210 where the operating system 220 transmits the enrollment request message based on the prompt provided to the computing device 105-a to initiate the enrollment. Moreover, an attestation that the computing device 105-a is associated with the organization may be based on the enrollment request message. In some examples, the data included in the enrollment request message may be from the one or more user 185 inputs from the user 185-a such that the attestation that the user 185-a is associated with the organization is based on the one or more user 185 inputs. Thus, at 350, the authentication server 215 may verify the device attestation of the computing device 105-a to determine and verify whether the computing device 105-a is a managed device and is managed by the user 185-b. Such attestation verification may occur prior to the computing device 105-a being enrolled in the authentication service 210 to ensure that only managed devices (e.g., computing devices 105 managed by administrative users 185 of an organization) are capable of enrolling within the authentication service 210.

In some examples, at 355, the operating system 220 may receive, from the authentication server 215, a response message indicating that the computing device 105-a is enrolled in the authentication service 210. Further, in some cases, the computing device 105-a being enrolled in the authentication service 210 may be based on the data of the enrollment request message. In some other examples, the operating system 220 may receive, from the authentication server 215 associated with the authentication service 210, an enrollment denial message that indicates a denial of the enrollment of the computing device 105-a in the authentication service 210 based on the attestation of the computing device 105-a. For example, the attestation of the computing device 105-a may indicate that the computing device 105-a is not a managed device or that the computing device 105-a is associated with a different organization than the organization of the user 185-b. Thus, the operating system 220 may display, at a first UI of the computing device 105-a, the enrollment denial message based on receiving the enrollment denial message from the authentication server 215.

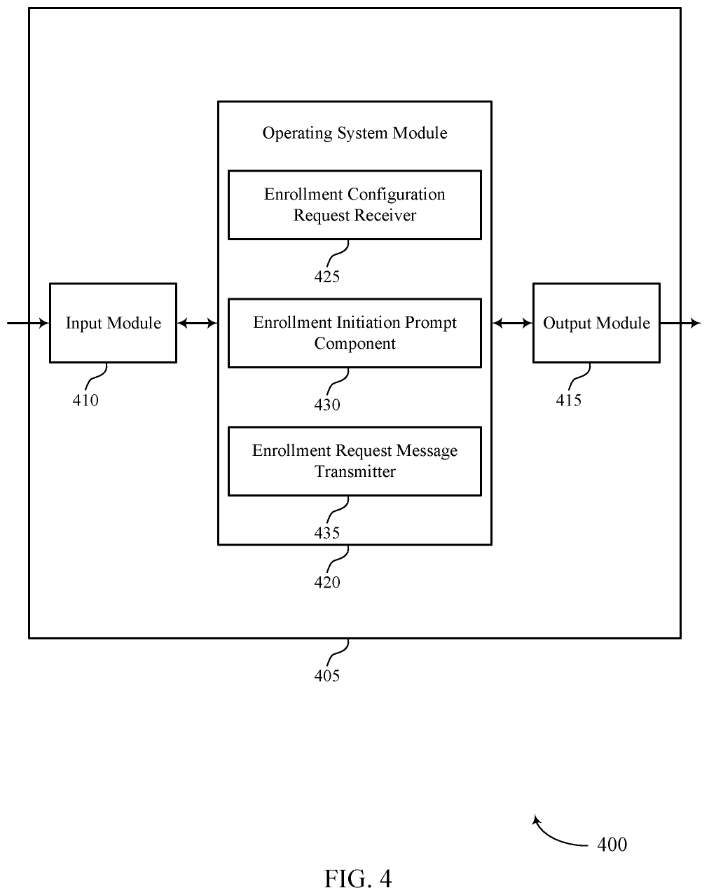

Therefore, the techniques of the present disclosure may ensure that the enrollment of a computing device 105 (e.g., the computing device 105-a) in the authentication service 210 is from a managed device (e.g., managed by the administrative user 185 of the organization associated with the device management provider 205 and the user 185-a) by performing device attestation prior to enrollment and that the enrollment is phishing resistant by having the operating system 220 initiate the enrollment. Further descriptions of the techniques of the present disclosure may be described elsewhere herein, such as with reference to FIGS. 4-7.

FIG. 4 shows a block diagram 400 of a device 405 that supports phishing resistant enrollment via an operating system in accordance with aspects of the present disclosure. The device 405 may include an input module 410, an output module 415, and an operating system module 420. The device 405, or one or more components of the device 405 (e.g., the input module 410, the output module 415, the operating system module 420), may include at least one processor, which may be coupled with at least one memory, to support the described techniques. Each of these components may be in communication with one another (e.g., via one or more buses).

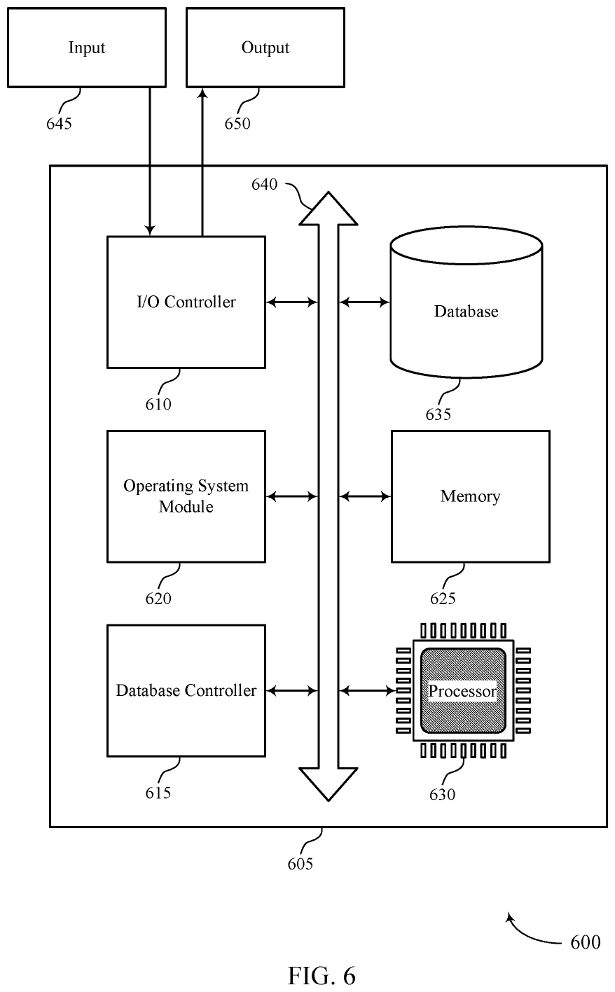

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the operating system module 420 to support phishing resistant enrollment via an operating system. In some cases, the input module 410 may be a component of an input/output (I/O) controller 610 as described with reference to FIG. 6.

The output module 415 may manage output signals for the device 405. For example, the output module 415 may receive signals from other components of the device 405, such as the operating system module 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the operating system module 420 may include an enrollment configuration request receiver 425, an enrollment initiation prompt component 430, an enrollment request message transmitter 435, or any combination thereof. In some examples, the operating system module 420, or various components thereof, may be configured to perform various operations (e.g., receiving, monitoring, transmitting) using or otherwise in cooperation with the input module 410, the output module 415, or both. For example, the operating system module 420 may receive information from the input module 410, send information to the output module 415, or be integrated in combination with the input module 410, the output module 415, or both to receive information, transmit information, or perform various other operations as described herein.

The operating system module 420 may support authentication service enrollment in accordance with examples as disclosed herein. The enrollment configuration request receiver 425 may be configured to support receiving, from a device management provider, an enrollment configuration request for an authentication service. The enrollment initiation prompt component 430 may be configured to support providing, to a first device associated with a first user, a prompt to initiate enrollment in the authentication service, the enrollment being in accordance with the enrollment configuration request, where the first device is managed by a second user of an organization that is different from the first user and is associated with the device management provider. The enrollment request message transmitter 435 may be configured to support transmitting, to an authentication server associated with the authentication service, an enrollment request message including data associated with the first device, the enrollment request message requesting the enrollment of the first device in the authentication service, where the enrollment request message is transmitted based on the prompt to initiate the enrollment, and where an attestation that the first device is associated with the organization is based on the enrollment request message.

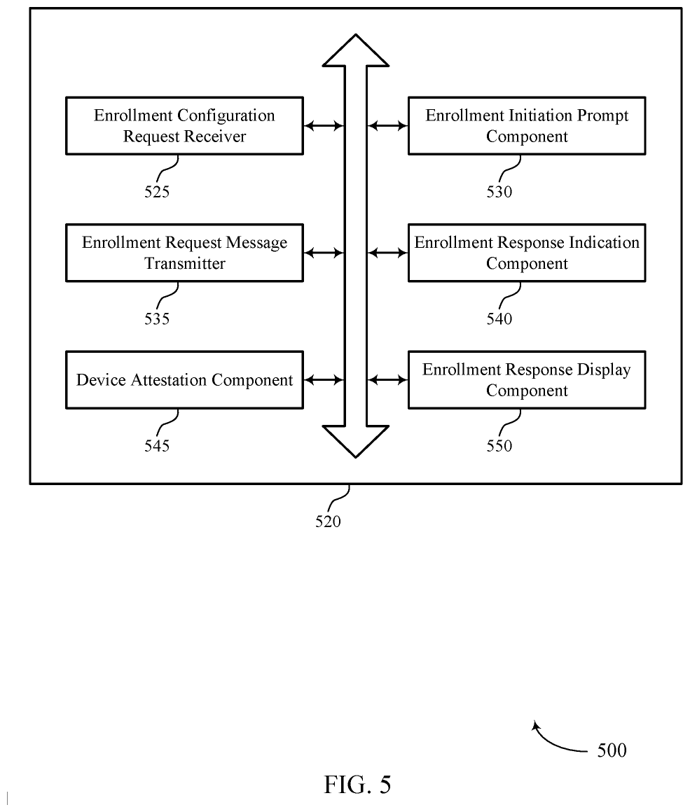

FIG. 5 shows a block diagram 500 of an operating system module 520 that supports phishing resistant enrollment via an operating system in accordance with aspects of the present disclosure. The operating system module 520 may be an example of aspects of an operating system module or an operating system module 420, or both, as described herein. The operating system module 520, or various components thereof, may be an example of means for performing various aspects of phishing resistant enrollment via an operating system as described herein. For example, the operating system module 520 may include an enrollment configuration request receiver 525, an enrollment initiation prompt component 530, an enrollment request message transmitter 535, an enrollment response indication component 540, a device attestation component 545, an enrollment response display component 550, or any combination thereof. Each of these components, or components of subcomponents thereof (e.g., one or more processors, one or more memories), may communicate, directly or indirectly, with one another (e.g., via one or more buses).

The operating system module 520 may support authentication service enrollment in accordance with examples as disclosed herein. The enrollment configuration request receiver 525 may be configured to support receiving, from a device management provider, an enrollment configuration request for an authentication service. The enrollment initiation prompt component 530 may be configured to support providing, to a first device associated with a first user, a prompt to initiate enrollment in the authentication service, the enrollment being in accordance with the enrollment configuration request, where the first device is managed by a second user of an organization that is different from the first user and is associated with the device management provider. The enrollment request message transmitter 535 may be configured to support transmitting, to an authentication server associated with the authentication service, an enrollment request message including data associated with the first device, the enrollment request message requesting the enrollment of the first device in the authentication service, where the enrollment request message is transmitted based on the prompt to initiate the enrollment, and where an attestation that the first device is associated with the organization is based on the enrollment request message.

In some examples, the enrollment response indication component 540 may be configured to support receiving, from the authentication server, a response message indicating that the first device is enrolled in the authentication service, the first device being enrolled in the authentication service based on the data of the enrollment request message.

In some examples, the device attestation component 545 may be configured to support generating a signed device attestation to indicate that the first device is associated with the organization of the device management provider using a signed authentication certificate issued by the device management provider associated with the organization, where the enrollment request message includes the signed device attestation.

In some examples, the enrollment response indication component 540 may be configured to support receiving, from the authentication server associated with the authentication service, an enrollment denial message that indicates a denial of the enrollment of the first device in the authentication service based on the attestation of the first device. In some examples, the enrollment response display component 550 may be configured to support displaying, at a first user interface of the first device, the enrollment denial message based on receiving the enrollment denial message.

In some examples, to support prompt to initiate the enrollment of the first device associated with the first user in the authentication service, the enrollment initiation prompt component 530 may be configured to support receiving, from the first user, one or more user inputs to associate the first user with the first device, the first device being associated with an identity provider that provides the authentication service.

In some examples, the prompt to initiate the enrollment in the authentication service is displayed at a first user interface of the first device.

In some examples, the second user of the organization associated with the device management provider is an administrative user for the device management provider.

FIG. 6 shows a diagram of a system 600 including a device 605 that supports phishing resistant enrollment via an operating system in accordance with aspects of the present disclosure. The device 605 may be an example of or include components of a device 405 as described herein. The device 605 may include components for bi-directional voice and data communications including components for transmitting and receiving communications, such as an operating system module 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting phishing resistant enrollment via an operating system). The processor 630 may be an example of a single processor or multiple processors. For example, the device 605 may include one or more processors 630.

The operating system module 620 may support authentication service enrollment in accordance with examples as disclosed herein. For example, the operating system module 620 may be configured to support receiving, from a device management provider, an enrollment configuration request for an authentication service. The operating system module 620 may be configured to support providing, to a first device associated with a first user, a prompt to initiate enrollment in the authentication service, the enrollment being in accordance with the enrollment configuration request, where the first device is managed by a second user of an organization that is different from the first user and is associated with the device management provider. The operating system module 620 may be configured to support transmitting, to an authentication server associated with the authentication service, an enrollment request message including data associated with the first device, the enrollment request message requesting the enrollment of the first device in the authentication service, where the enrollment request message is transmitted based on the prompt to initiate the enrollment, and where an attestation that the first device is associated with the organization is based on the enrollment request message.

By including or configuring the operating system module 620 in accordance with examples as described herein, the device 605 may support techniques for enabling phishing resistant enrollment to support more secure authentication systems.

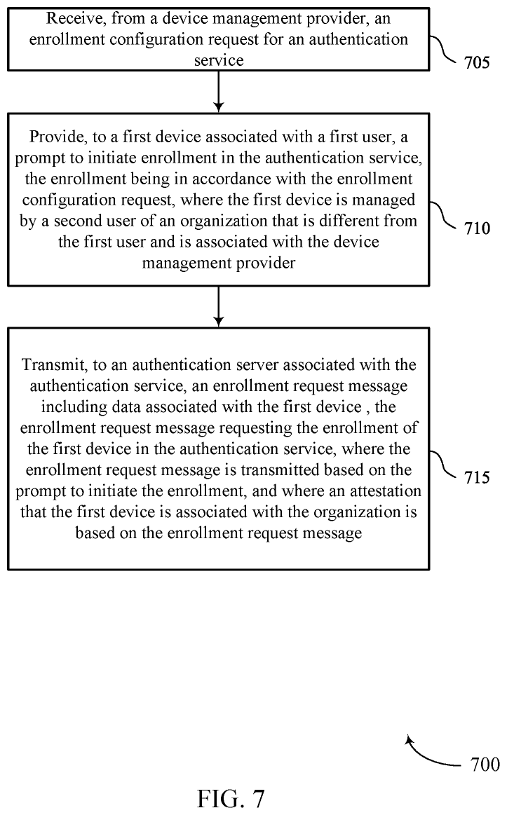

FIG. 7 shows a flowchart illustrating a method 700 that supports phishing resistant enrollment via an operating system in accordance with aspects of the present disclosure. The operations of the method 700 may be implemented by a computing device or its components as described herein. For example, the operations of the method 700 may be performed by a computing device as described with reference to FIGS. 1 through 6. In some examples, a computing device may execute a set of instructions to control the functional elements of the computing device to perform the described functions. Additionally, or alternatively, the computing device may perform aspects of the described functions using special-purpose hardware.

At 705, the method may include receiving, from a device management provider, an enrollment configuration request for an authentication service. The operations of 705 may be performed in accordance with examples as disclosed herein. In some examples, aspects of the operations of 705 may be performed by an enrollment configuration request receiver 525 as described with reference to FIG. 5.

At 710, the method may include providing, to a first device associated with a first user, a prompt to initiate enrollment in the authentication service, the enrollment being in accordance with the enrollment configuration request, where the first device is managed by a second user of an organization that is different from the first user and is associated with the device management provider. The operations of 710 may be performed in accordance with examples as disclosed herein. In some examples, aspects of the operations of 710 may be performed by an enrollment initiation prompt component 530 as described with reference to FIG. 5.

At 715, the method may include transmitting, to an authentication server associated with the authentication service, an enrollment request message including data associated with the first device, the enrollment request message requesting the enrollment of the first device in the authentication service, where the enrollment request message is transmitted based on the prompt to initiate the enrollment, and where an attestation that the first device is associated with the organization is based on the enrollment request message.

The operations of 715 may be performed in accordance with examples as disclosed herein. In some examples, aspects of the operations of 715 may be performed by an enrollment request message transmitter 535 as described with reference to FIG. 5.

The following provides an overview of aspects of the present disclosure:
Aspect 1: A method for authentication service enrollment, comprising: receiving, from a device management provider, an enrollment configuration request for an authentication service; providing, to a first device associated with a first user, a prompt to initiate enrollment in the authentication service, the enrollment being in accordance with the enrollment configuration request, wherein the first device is managed by a second user of an organization that is different from the first user and is associated with the device management provider; and transmitting, to an authentication server associated with the authentication service, an enrollment request message comprising data associated with the first device, the enrollment request message requesting the enrollment of the first device in the authentication service, wherein the enrollment request message is transmitted based at least in part on the prompt to initiate the enrollment, and wherein an attestation that the first device is associated with the organization is based at least in part on the enrollment request message.
Aspect 2: The method of aspect 1, further comprising: receiving, from the authentication server, a response message indicating that the first device is enrolled in the authentication service, the first device being enrolled in the authentication service based at least in part on the data of the enrollment request message.
Aspect 3: The method of any of aspects 1 through 2, further comprising: generating a signed device attestation to indicate that the first device is associated with the organization of the device management provider using a signed authentication certificate issued by the device management provider associated with the organization, wherein the enrollment request message comprises the signed device attestation.
Aspect 4: The method of any of aspects 1 through 3, further comprising: receiving, from the authentication server associated with the authentication service, an enrollment denial message that indicates a denial of the enrollment of the first device in the authentication service based at least in part on the attestation of the first device; and displaying, at a first user interface of the first device, the enrollment denial message based at least in part on receiving the enrollment denial message.
Aspect 5: The method of any of aspects 1 through 4, wherein the prompt to initiate the enrollment of the first device associated with the first user in the authentication service comprises: receiving, from the first user, one or more user inputs to associate the first user with the first device, the first device being associated with an identity provider that provides the authentication service.
Aspect 6: The method of any of aspects 1 through 5, wherein the prompt to initiate the enrollment in the authentication service is displayed at a first user interface of the first device.
Aspect 7: The method of any of aspects 1 through 6, wherein the second user of the organization associated with the device management provider is an administrative user for the device management provider.
Aspect 8: An apparatus for authentication service enrollment, comprising one or more memories storing processor-executable code, and one or more processors coupled with the one or more memories and individually or collectively operable to execute the code to cause the apparatus to perform a method of any of aspects 1 through 7.
Aspect 9: An apparatus for authentication service enrollment, comprising at least one means for performing a method of any of aspects 1 through 7.
Aspect 10: A non-transitory computer-readable medium storing code for authentication service enrollment, the code comprising instructions executable by one or more processors to perform a method of any of aspects 1 through 7.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for authentication service enrollment, comprising:
receiving, from a device management provider, an enrollment configuration request for an authentication service;
providing, to a first device associated with a first user, a prompt to initiate enrollment in the authentication service, the enrollment being in accordance with the enrollment configuration request, wherein the first device is managed by a second user of an organization that is different from the first user and is associated with the device management provider; and
transmitting, to an authentication server associated with the authentication service, an enrollment request message comprising data associated with the first device, the enrollment request message requesting the enrollment of the first device in the authentication service, wherein the enrollment request message is transmitted based at least in part on the prompt to initiate the enrollment, and wherein an attestation that the first device is associated with the organization is based at least in part on the enrollment request message.

2. The method of claim 1, further comprising:
receiving, from the authentication server, a response message indicating that the first device is enrolled in the authentication service, the first device being enrolled in the authentication service based at least in part on the data of the enrollment request message.

3. The method of claim 1, further comprising:
generating a signed device attestation to indicate that the first device is associated with the organization of the device management provider using a signed authentication certificate issued by the device management provider associated with the organization, wherein the enrollment request message comprises the signed device attestation.

4. The method of claim 1, further comprising:
receiving, from the authentication server associated with the authentication service, an enrollment denial message that indicates a denial of the enrollment of the first device in the authentication service based at least in part on the attestation of the first device; and
displaying, at a first user interface of the first device, the enrollment denial message based at least in part on receiving the enrollment denial message.

5. The method of claim 1, wherein the prompt to initiate the enrollment of the first device associated with the first user in the authentication service comprises:
receiving, from the first user, one or more user inputs to associate the first user with the first device, the first device being associated with an identity provider that provides the authentication service.

6. The method of claim 1, wherein the prompt to initiate the enrollment in the authentication service is displayed at a first user interface of the first device.

7. The method of claim 1, wherein the second user of the organization associated with the device management provider is an administrative user for the device management provider.

8. An apparatus for authentication service enrollment, comprising:
one or more memories storing processor-executable code; and
one or more processors coupled with the one or more memories and individually or collectively operable to execute the code to cause the apparatus to:
receive, from a device management provider, an enrollment configuration request for an authentication service;
provide, to a first device associated with a first user, a prompt to initiate enrollment in the authentication service, the enrollment being in accordance with the enrollment configuration request, wherein the first device is managed by a second user of an organization that is different from the first user and is associated with the device management provider; and
transmit, to an authentication server associated with the authentication service, an enrollment request message comprising data associated with the first device, the enrollment request message requesting the enrollment of the first device in the authentication service, wherein the enrollment request message is transmitted based at least in part on the prompt to initiate the enrollment, and wherein an attestation that the first device is associated with the organization is based at least in part on the enrollment request message.

9. The apparatus of claim 8, wherein the one or more processors are individually or collectively further operable to execute the code to cause the apparatus to:
receive, from the authentication server, a response message indicating that the first device is enrolled in the authentication service, the first device being enrolled in the authentication service based at least in part on the data of the enrollment request message.

10. The apparatus of claim 8, wherein the one or more processors are individually or collectively further operable to execute the code to cause the apparatus to:
generate a signed device attestation to indicate that the first device is associated with the organization of the device management provider using a signed authentication certificate issued by the device management provider associated with the organization, wherein the enrollment request message comprises the signed device attestation.

11. The apparatus of claim 8, wherein the one or more processors are individually or collectively further operable to execute the code to cause the apparatus to:
receive, from the authentication server associated with the authentication service, an enrollment denial message that indicates a denial of the enrollment of the first device in the authentication service based at least in part on the attestation of the first device; and
display, at a first user interface of the first device, the enrollment denial message based at least in part on receiving the enrollment denial message.

12. The apparatus of claim 8, wherein, to prompt to initiate the enrollment of the first device associated with the first user in the authentication service, the one or more processors are individually or collectively operable to execute the code to cause the apparatus to:
receive, from the first user, one or more user inputs to associate the first user with the first device, the first device being associated with an identity provider that provides the authentication service.

13. The apparatus of claim 8, wherein the prompt to initiate the enrollment in the authentication service is displayed at a first user interface of the first device.

14. The apparatus of claim 8, wherein the second user of the organization associated with the device management provider is an administrative user for the device management provider.

15. A non-transitory computer-readable medium storing code for authentication service enrollment, the code comprising instructions executable by one or more processors to:
receive, from a device management provider, an enrollment configuration request for an authentication service;
provide, to a first device associated with a first user, a prompt to initiate enrollment in the authentication service, the enrollment being in accordance with the enrollment configuration request, wherein the first device is managed by a second user of an organization that is different from the first user and is associated with the device management provider; and
transmit, to an authentication server associated with the authentication service, an enrollment request message comprising data associated with the first device, the enrollment request message requesting the enrollment of the first device in the authentication service, wherein the enrollment request message is transmitted based at least in part on the prompt to initiate the enrollment, and wherein an attestation that the first device is associated with the organization is based at least in part on the enrollment request message.

16. The non-transitory computer-readable medium of claim 15, wherein the instructions are further executable by the one or more processors to:
receive, from the authentication server, a response message indicating that the first device is enrolled in the authentication service, the first device being enrolled in the authentication service based at least in part on the data of the enrollment request message.

17. The non-transitory computer-readable medium of claim 15, wherein the instructions are further executable by the one or more processors to:
generate a signed device attestation to indicate that the first device is associated with the organization of the device management provider using a signed authentication certificate issued by the device management provider associated with the organization, wherein the enrollment request message comprises the signed device attestation.

18. The non-transitory computer-readable medium of claim 15, wherein the instructions are further executable by the one or more processors to:
receive, from the authentication server associated with the authentication service, an enrollment denial message that indicates a denial of the enrollment of the first device in the authentication service based at least in part on the attestation of the first device; and
display, at a first user interface of the first device, the enrollment denial message based at least in part on receiving the enrollment denial message.

19. The non-transitory computer-readable medium of claim 15, wherein the instructions to prompt to initiate the enrollment of the first device associated with the first user in the authentication service are executable by the one or more processors to:
receive, from the first user, one or more user inputs to associate the first user with the first device, the first device being associated with an identity provider that provides the authentication service.

20. The non-transitory computer-readable medium of claim 15, wherein the second user of the organization associated with the device management provider is an administrative user for the device management provider.
